(19) United States
(12) Patent Application Publication
(10) Pub. No.: US 2024/0183111 A1
(43) Pub. Date: Jun. 6, 2024

(54) AQUEOUS BARRIER COATINGS AND METHODS OF IMPROVING BARRIER PROPERTIES OF PACKAGING MATERIALS

(71) Applicant: SOLENIS TECHNOLOGIES, L.P., Wilmington, DE (US)

(72) Inventors: Yannick Evrard, Wommelgem (BE); Mike Thijs, Borgerhout (BE)

(73) Assignee: SOLENIS TECHNOLOGIES, L.P., Wilmington, DE (US)

(21) Appl. No.: 18/523,931

(22) Filed: Nov. 30, 2023

Related U.S. Application Data
(60) Provisional application No. 63/385,806, filed on Dec. 2, 2022.

(51) Int. Cl. D21H 27/10; B65D 65/40; B65D 65/42; B65D 65/46; C09D 5/00; C09D 7/65; C09D 103/04; C09D 109/08; C09D 125/14; C09D 129/04; C09D 133/04; D21H 19/12; D21H 19/40; D21H 19/54; D21H 19/82; D21H 21/16; D21H 23/72

(52) U.S. Cl. CPC D21H 27/10; B65D 65/40; B65D 65/42; B65D 65/466; C09D 5/002; C09D 7/65; C09D 103/04; C09D 109/08; C09D 125/14; C09D 129/04; C09D 133/04; D21H 19/12; D21H 19/40; D21H 19/54; D21H 19/82; D21H 21/16; D21H 23/72; B65D 2565/388

(57) ABSTRACT

An aqueous paper barrier coating and methods for improving barrier properties of packaging material are described. The packaging material includes a substrate with coatings to provide a packaging material having tailored moisture vapor transmission, oxygen permeation or transmission, oil and grease resistance, and light properties.

This application claims the benefit of U.S. Provisional application No. 63/385,806, filed Dec. 2, 2022, the entire contents of which are hereby incorporated by reference.

### TECHNICAL FIELD

An aqueous barrier coating and methods for improving barrier properties of packaging material are described. The packaging material includes a substrate with coatings to provide a packaging material having tailored moisture vapor transmission, oxygen permeation or transmission, oil and grease resistance, and light properties.

### BACKGROUND

The packaging material may be a flexible packaging material. which can be defined as any package or part of a package whose shape can readily be changed when filled or during use. Flexible packaging is produced from paper. plastic. film. aluminum foil. or any combination of those materials. and includes bags, pouches, liners, wraps, rollstock, and other flexible products.

Flexible packaging is replacing more traditional packaging, such as glass jars and metal cans, more and more each year as its benefits are acknowledged. These benefits include extended shelf life, improved cost economics, lower pack weights and lower transport costs. However, most used flexible packaging materials today are plastics in combination with aluminum foil. With the rising costs of both fossil fuel-based materials and aluminum, as well as their environmental impacts, the market needs to transition towards more sustainable materials.

Paper based packaging is being used more and more in packaging for foodstuff, healthcare, and cosmetics because of its high degree of biodegradability, recyclability, and bio-based content.

However, paper-based products have to be treated or coated since uncoated paper offers less of a barrier to water (vapor), oxygen, and grease than do other packaging materials, for example, foodstuffs, medicines, and cosmetics. These are problematic since these products can be damaged or can deteriorate by contact with water (vapor) and oxygen entering the packaging very quickly. Another issue with untreated paper-based packaging is if the contents are greasy then grease can migrate through the packaging and will show stains on the outside of the package. Moisture presents other issues for uncoated paper since it will take up water, soften and lose its structural strength.

Conventional solutions to increase the poor barrier performance of paper-based packaging is to apply a laminate to the surface of the substrate. Lamination of paper generally involves coating the surface with an inert resin, which is cured to form a hard composite with the structure of paper. However, there are many examples in which laminated paper caused issues in typical commercial paper recycling systems, like clogging of the filters in the repulping system, lower percentages of repulped paper fibers and plastics being incorporated into the recycled paper resulting in a decline of aesthetic and performance properties.

Other methods involve applying a plastic coating, such as, a polypropylene (PP) or a polyethylene (PE) layer onto the surface of the paper. This is done using coating, printing, or lamination processes. However, applying a plastic coating to paper results in disadvantages towards the recyclability and biodegradability of the paper-based material because of the strong adhesion of the plastic to the paper fibers.

Other methods to increase the barrier performance of paper-based materials is to apply an aqueous barrier coating onto the surface of the paper. Because the formulations do not contain polymers such as PP or PE, the packaging can be more easily recycled and have less of an environmental impact. However, results have shown these types of coatings do not perform as well when compared with paper-based laminates.

Another technique for imparting barrier characteristics to paper is to treat the substrate with a polyvinyl alcohol solution. A typical polyvinyl alcohol solution has a low solid content combined with a high viscosity. However, it is problematic to apply the product using a conventional paper coating machine, due to the runnability at high paper machine speeds, the drying capacity, and the higher price of the product. In addition, polyvinyl alcohol may be biodegradable in optimal circumstances, but it is still a fossil-fuel based polymeric product.

There is still a strong need for water-based barrier coatings, or a combination thereof, with a maximum amount of non-fossil fuel content in paper-based packaging to give better barrier properties against water (vapor), oxygen and/or grease.

### BRIEF SUMMARY

Provided is a substrate, such as paper or fiber, having improved barrier properties. The substrate will have an outermost surface and an innermost surface disposed opposite one another. Disposed on and in direct contact with the outermost, innermost or both surfaces of the substrate, is one or more optional primer coatings, followed by a biodegradable coating. The biodegradable coating can be disposed directly on the surface of the substrate or disposed on the optional one or more primer coatings. A hydrophobic heat-sealable topcoat layer is being disposed on the biodegradable coating layer.

Also provided is a method of improving barrier properties of a substrate, such as a paper or fiber substrate. The method includes providing the substrate, which has an outermost surface and an innermost surface disposed opposite one another. An optional primer or first coating can be applied on and in direct contact with the outermost surface, innermost surface, or both surfaces of the substrate forming a first coating layer on the substrate surface. This is followed by applying a biodegradable coating either directly to the substrate or on the primer or first coating layer if present. Additional polymeric coatings can be applied to the surface of the biodegradable coating layer prior to a final or topcoat layer. A topcoat or final coating layer is applied to the surface of the biodegradable or optional polymeric or outermost coating layer. The substrate can have just the biodegradable coating followed by the topcoat layer or additional coatings can be disposed on the substrate prior to the biodegradable coating layer or subsequent to the biodegradable coating layer.

This summary is provided to introduce a selection of concepts in a simplified form that are further described below in the detailed description. This summary is not intended to identify key features or essential features of the claimed subject matter nor is it intended to be used as an aid in determining the scope of the claimed subject matter.

### DETAILED DESCRIPTION

Provided is a substrate having a barrier coating starting from at least two aqueous barrier coating layers including a first biodegradable coating layer, and a second hydrophobic topcoat layer. The coating layers are applied on top of each other, wherein each layer has a designated function. The substrate can also have a multilayer configuration wherein one or more pre-coats or primer coatings are applied prior to subsequent to the biodegradable and/or topcoat layers. For example, the present substrate can comprise a primer coating containing a primer coating, which is a highly pigmented barrier coating, followed by a second coating comprising a polyvinyl alcohol solution, and a topcoat containing a hydrophobic and/or heat-sealable polymeric coating. Surprisingly, it was found that this configuration of coating layers provided unexpected results in terms of moisture vapor transmission barrier, oxygen transmission barrier and grease barrier.

In some aspects of the substrate, the substrate is a paper or fiber product having two or more barrier coatings applied to the substrate in layers, thereby improving the barrier properties of the substrate.

A barrier coating, blocks the passage of various substances including: water, moisture vapor, oils, and grease under a wide range of conditions and temperatures. Moisture vapor transmission rate (MVTR), sometimes called water vapor transmission rate (WVTR), is a measure of the passage of water vapor through a substrate during a period of time. There are many applications where moisture control is critical.

The substrate has an outermost surface and an innermost surface disposed opposite one another. Disposed on and in direct contact with one or both surfaces of the substrate is an optional aqueous primer coating, a biodegradable aqueous coating disposed on the substrate or optional primer coating, followed by an aqueous topcoat. The topcoat can be an outermost coating layer or additional coatings may be disposed upon the topcoat layer.

In some aspects, the substrate is a paper product having a top or outermost surface and an innermost or bottom surface. Optionally, one or more aqueous primer coatings is disposed on one or both surfaces of the substrate forming one or more coating layers on the substrate. A biodegradable aqueous coating is disposed on the surface of the substrate or the optional primer coating layer(s). One or more additional polymeric coatings can optionally be disposed on the biodegradable coating layer. A topcoat, which is generally the outermost coating is disposed upon the surface of the biodegradable coating layer or optional additional coating layers. However, additional polymeric coatings can be disposed on the surface of the topcoat as long as the topcoat layer is outermost to the biodegradable coating layer.

In some aspects, the substrate has one or more primer coatings disposed on and in direct contact with the outermost surface of the substrate followed by a biodegradable coating, optional additional polymeric coatings, and a topcoat. Optionally, additional polymeric coatings can be disposed on the topcoat.

In some aspects of the substrate, the primer coating is a water borne coating containing one or more polymeric emulsions and an inorganic pigment slurry. The polymeric emulsion can be chosen from styrene butadiene, styrene acrylate, polyethylene, polypropylene, polyethylene oxide, polyacrylate, polyvinyl alcohol, polyvinyl acetate, polyvinyl amine, or combinations thereof. The inorganic pigment slurry can be chosen from talc, kaolin, calcium carbonate, mica, montmorillonite, or combinations thereof.

In some aspects, the primer coating contains a polymeric content of from about 30 wt. % to about 70 wt. % and a pigment content from about 30 wt. % to about 70 wt. % based on total dry weight of the primer coating, or a polymeric content from about 30 wt. % and 50% and a pigment content from about 50 wt. % and 70 wt. % based on total dry weight of the primer coating, or a polymeric content from about 30 wt. % and 40 wt. % and a pigment content from about 60 wt. % and 70% based on total dry weight of the primer coating.

In some aspects, the biodegradable coating is a water borne coating containing one or more biodegradable polymeric emulsion, inorganic pigment(s), and plasticizer(s). The one or more biodegradable polymeric emulsions can be chosen from polyvinyl alcohol, polyethylene oxide, methylcellulose, cellulose acetate, sodium alginate, polyhydroxy alkanoates, polylactic acid, silk fibroin, soy protein, chitosan, thermoplastic starch, crosslinked starch, or combinations thereof. The inorganic pigment can be chosen from talc, kaolin, calcium carbonate, mica, montmorillonite, or combinations thereof. The plasticizer can be chosen from sugar alcohols, glycerol, propylene glycol, glyceryl triacetate, polymeric polyols, urea, ethanol, isopropanol, or combinations thereof.

In other aspects, the biodegradable coating has a biodegradable polymeric content from about 40 wt. % and 100 wt. % based on the total dry weight of the biodegradable coating, a pigment content from 0 wt. % to about 50 wt. % and a plasticizer content from 0) wt. % to about 20 wt. % based on the total dry weight of the biodegradable coating, or a biodegradable polymer content from about 50 wt. % to about 80 wt. %, a pigment content from about 10 wt. % to about 40% and a plasticizer content from 0) wt. % to about 20 wt. % based on the total dry weight of the biodegradable coating, or a biodegradable polymeric content from about 50) wt. % to about 70 wt. %, a pigment content from about 25 and 35% and a plasticizer content from about 5 wt. % to about 15 wt. % based on the total dry weight of the biodegradable coating.

In some aspects, the topcoat is a water borne coating that contains one or more polymeric emulsions and optionally, one or more wax emulsions. The polymeric emulsion of the topcoat layer can be chosen from styrene butadiene, styrene acrylate, polyethylene, polypropylene, polyethylene oxide, polyacry late, polyvinyl alcohol, polyvinyl acetate, polyvinyl amine, or combinations thereof; and the wax emulsion of the topcoat coating layer can be chosen from a paraffin, polyethylene, montan, palm, palm kernel, coconut, rapeseed, soy bean, sunflower, castor, carnauba, beeswax, shellac, candelilla, sugar cane, rice bran, stearates, laurates, oleates, or combinations thereof.

In some aspects, the topcoat has a polymeric content of from about 50 wt. % to about 100 wt. %, and a wax content from about 0 and 50 wt. % based on the total dry weight of the topcoat, or a polymeric content from about wt. % to about 90 wt. %, and a wax content from about 10 wt. % and 40 wt. % based on the total dry weight of the topcoat, or a polymeric content from about 70 wt. % and 80 wt. % and a wax content from about 20 wt. % and 30 wt. % based on the total dry weight of the topcoat.

In some aspects, the coated substrate has a primer coating layer and a biodegradable coating layer, wherein the primer coating layer can be disposed on the substrate at a dry coat weight of from about from 1 to about 50 grams/meter squared (g/m²) or from about 5 g/m² to about 20 g/m², and the biodegradable coating layer can be disposed on the primer coating layer at a dry coat weight of from about 1 g/m² to about 50 g/m², or from about 5 g/m² to about 20 g/m².

In some aspects, the topcoat layer is disposed at a dry coat weight of from about 1 g/m² to about 50 g/m², or from about 5 g/m² to about 20 g/m².

In yet other aspects, the substrate is a paper or fiber product, and the coatings are disposed on the innermost surface, the outermost surface, or both.

Also provided is a method for improved barrier properties of a substrate. The method includes providing a substrate having an outermost surface and an innermost surface disposed opposite one another and applying a biodegradable coating to the outermost, innermost, or both surfaces of the substrate. A topcoat is then applied to the surface of the biodegradable coating.

In one aspect of the method, a first coating is applied on top of the paper substrate, which can be a primer coating or a biodegradable coating. This coating is designed to close off the surface of the paper and provides additional moisture vapor barrier. The second layer, or middle coating, provides an oxygen barrier, but needs to be shielded from moisture vapor. If too much moisture is taken up, due to the coating's hydrophilic nature, the performance of the oxygen barrier will be negatively impacted. The topcoat or third layer, provides a moisture vapor barrier and heat sealability to close off the paper-based packaging.

In some aspects of the method, one or more primer coating layers can be applied to the substrate, followed by a biodegradable coating, followed by one or more additional primer coating layers, followed by a topcoat.

In other aspects of the method, additional primer coating layers can be applied subsequent to the biodegradable coating and/or topcoat layer.

In some aspects of the method, the optional one or more primer coatings is a water borne coating containing one or more polymeric emulsions and an inorganic pigment slurry. The polymeric emulsion can be chosen from styrene butadiene, styrene acrylate, polyethylene, polypropylene, polyethylene oxide, polyacrylate, polyvinyl alcohol, polyvinyl acetate, polyvinyl amine, or combinations thereof. The inorganic pigment slurry can be chosen from talc, kaolin, calcium carbonate, mica, montmorillonite, or combinations thereof.

In yet other aspects of the method, the optional one or more primer coatings can be applied prior to or subsequent to the biodegradable coating.

In some aspects, the primer layer has a polymeric content from about 30 wt. % to about 70 wt. %, and a pigment content from about 30 wt. % to about 70 wt. % based on the total weight of the primer coating; or a polymeric content from about 30% to about 50 wt. %, and a pigment content from about 50 wt. % to about 70 wt. % based on the total weight of the primer coating; or a polymeric content from about 30 wt. % to about 40 wt. %, and a pigment content from about 60 wt. % to about 70 wt. % based on the total weight of the primer coating.

In some aspects of the coated paper product, the biodegradable coating layer is a water borne coating containing at least one biodegradable polymeric emulsion, and optionally an inorganic pigment, and plasticizer. The biodegradable polymeric emulsion is chosen from at least one of polyvinyl alcohol, polyethylene oxide, methylcellulose, cellulose acetate, sodium alginate, polyhydroxy alkanoates, polylactic acid, silk fibroin, soy protein, chitosan, thermoplastic starch, crosslinked starch, or combinations thereof. The inorganic pigment can be chosen from talc, kaolin, calcium carbonate, mica, montmorillonite, or combinations thereof. The plasticizer can be chosen from sugar alcohols, glycerol, propylene glycol, glyceryl triacetate, polymeric polyols, urea, ethanol, isopropanol, or combinations thereof.

In some aspects, the biodegradable coating layer has a biodegradable polymeric content of from about 40 wt. % to about 100 wt. %, a pigment content from 0) to about 50 wt. %, and a plasticizer content from 0 to about 20 wt. % based on the total weight of the biodegradable coating, or a biodegradable polymeric content of from about 50 wt. % to about 80 wt. %, a pigment content from about 10 wt. % to about 40 wt. %, and a plasticizer content from 0 wt. % to about 20 wt. % based on the total weight of the biodegradable coating, or a biodegradable polymeric content of from about 50 wt. % to about 70 wt. %, a pigment content from about 25 wt. % to about 35 wt. % and a plasticizer content from about 5 wt. % to about 15 wt. % based on the total weight of the biodegradable coating.

In some aspects of current method, the topcoat is a water borne coating that contains one or more polymeric emulsions and optionally, one or more wax emulsions. The composition of the water borne coating for the topcoat layer has a polymeric content from about 50 wt. % to about 100 wt. %, and a wax content from 0 wt. % to about 50 wt. % based on the total weight of the topcoat; or a polymeric content from about 60 wt. % to about 90 wt. %, and a wax content from about 10 to about 40% based on the total weight of the topcoat; or a polymeric content from about 70 wt. % to about 80 wt. %, and a wax content from about 20 wt. % to about 30 wt. % based on the total weight of the topcoat.

In some aspects of the current method, the polymeric emulsion of the topcoat layer can be chosen from styrene butadiene, styrene acrylate, polyethylene, polypropylene, polyethylene oxide, polyacrylate, polyvinyl alcohol, polyvinyl acetate, polyvinyl amine, or combinations thereof; and the wax emulsion of the topcoat coating layer can be chosen from a paraffin, polyethylene, montan, palm, palm kernel, coconut, rapeseed, soy bean, sunflower, castor, carnauba, beeswax, shellac, candelilla, sugar cane, rice bran, stearates, laurates, oleates, or combinations thereof.

In other aspects of the method, the primer coating layer can be applied at a dry coat weight of from about 1 grams/meter squared (g/m²) to about 50 g/m²; or from about 5 g/m² to about 20 g/m².

In yet other aspects of the method, the biodegradable coating layer is applied at a dry coat weight of from about 1 g/m² to about 50 g/m², or from about 5 g/m² to about 20 g/m².

In yet other aspects of the method, the topcoat coating layer is applied at a dry coat weight of from about 1 g/m² to about 50 g/m²; or about 5 g/m² to about 20 g/m².

### EXAMPLES

As used herein, the term “water vapor transmission rate” or “WVTR” refers to the rate at which water vapor is transmitted through a film or substrate, when measured according to the Water Vapor Transmission Test Method set forth in the Test Methods section.

As used herein, the term “oxygen transmission rate” or “OTR” refers to the rate at which water vapor is transmitted through a film or substrate, when measured according to the Oxygen Transmission Test Method set forth in the Test Methods section.

Initially, work was started by coating a paper substrate with a starch-based material, which provided a good oil and grease (OGR) barrier for applications where either a thick coating layer or multiple layers could be applied. However, the desired results were to develop a coating that provided better or increase barrier protection than currently available.

It was then determined to try a biowax-based coating on the substrate. The coating was applied on molded fiber via spray in which there was great need for an OGR barrier with a maximum amount of non-fossil fuel content. Spraying allowed for the application of a thick layer so comparison with the starch-based coating could be accomplished.

The following detailed description is merely exemplary in nature and is not intended to limit the invention or the application and uses of the invention. Unless specifically stated or obvious from context. as used herein. the term “about” is understood as within a range of normal tolerance in the art. For example, within 2 standard deviations of the mean. “about” can be understood as within 10 wt. %, 5 wt. %, 1 wt. %, 0.5 wt. %, 0.1 wt. %, 0.05%, or 0.01 wt. % of the stated value. “About” can alternatively be understood as implying the exact value stated. Unless otherwise clear from the context. all numerical values provided herein are modified by the term “about.”

The following studies were done in an effort to provide an aqueous barrier coating system having grease, MOSH/MOAH, and water barrier properties as good or better than barrier coating containing fossil fuel content. In the study, 2-layers of an aqueous bio-wax coating were applied to a paper substrate and heptane barrier testing was done. Results indicated when a second aqueous bio-wax coating was disposed on the first aqueous coating, the substrate had improved barrier properties.

Based on these results, additional aqueous non-fossil fuel coatings were studied. In particular, biowax-based barrier coatings that are plastic and paraffin-free and derived from vegetable oils. Biowax barrier coatings are also free from harmful mineral oil saturated hydrocarbons (MOSH) and mineral oil aromatic hydrocarbons (MOAH) were tested.

Tests were done using several combinations of Topscreen™ products (Solenis, LLC) to determine which of the various biowax-based products provided the best results with regard to barrier properties.

Studies were done on paper samples, which were coated in the lab using an RK Print Coat Instruments Ltd. K Printing Proofer using the following settings, V=220/240; Hz=50-60; A=2; Ph=1.

As a first step, the coater was calibrated followed by the actual coating and drying processes. The last step includes determining the coating weight of each sample using formula and procedure described below.

The coater settings are displayed as CxVxMx; wherein C=identification number of the coater, V=speed setting of the speed dial on the coater, and M=groove size of the coating bar, the higher the coating number of the bar, the more coating is applied. For example: A sheet coated by settings C3V4M6 means it was coated on coater 3, at a speed of 4 and using the bar with groove 6. The coating machine settings used in each study can be found in the tables below.

After calibration of the paper coater was done according to standard operating guidelines, the following procedure was followed to coat the paper substrate. 1) A blank sheet of paper was clamped at the top of the coater; 2) a coating bar was used and slid through the retaining plates of the coater without any pressure and without lifting the weights. The coating bar depends on the desired coating weight: 3) the paper sheet was coated leaving the top half blank. This is necessary for the coat weight determination: 4) machine speed was adjusted to give the desired coat weights as described below; 5) a thin line of coating was spread across the paper and parallel to the coater bar the bar is dragged across the surface of the paper; and 6) the coated sheet was placed in the oven and dried at a temperature of 120° C. for 1 minute or until dry.

Coating weight was determined on the coated paper as follows: When the coated paper had cooled down, samples are obtained by cutting out and weighing a predetermined size circle of the blank or uncoated paper and the coated paper. The coat weight can be calculated as follows:

coat weight=(weight coated circle−weight blank circle)×168

wherein, after the samples have acclimatized, the circles are reweighed again to determine the stabilized coat weight.

The following products were used in the following studies: TopScreen™ DS 54T is a primer coating containing a poly acrylate binder; TopScreen™ RP 105 is a formulation comprising styrene acrylate latexes and biowax; TopScreen™ HB 50A is a formulation comprising of a polyacrylic binder and low amount of biowax; TopScreen™ HB 21 is a formulation comprising of a polyacrylic binder and high amount of biowax

### Example 1

In this study, the penetration of a polar substance is simulated by using n-heptane. Test samples were prepared in which 86 mm diameter circles were cut from coated sheets. The moisture barrier for mineral oils was measured in g/m² and the typical condition settings of the climate chamber was either 23° C. 50% relative humidity (RH) or 25° C. 50% RH (T448 om-97). Under these conditions, the coated side of the paper was exposed to a glass jar containing 20 milliliter (ml) n-heptane. A rubber gasket was then placed on top of the coated paper and the open stopper (lid) is screwed onto the jar to create a climate-controlled environment. The papers were tested every 24 hours over four days by weighing the jars and replacing them in the climate-controlled environment.

At the end of the four days a value for the total amount of n-heptane that escaped through the paper is obtained and expressed in g/m²/day.

Two paper samples were tested in this study, which were designated as Sample 1 and Sample 2. Several coating combinations were tested with a single layer of coating or a combination of a topcoat and a primer coating. All coating combinations were tested on Sample 2 (Table 1a) and depending on the results, were then tested on Sample 1 (Table 1b). The coating layers and MOSH/MOAH measurements for each sample can be found in Tables 1a and 1b.

TABLE 1a
Test results MOSH MOAH

| | MOSH MOAH |
|---|---|
| Sample 2 - Testing | (g/m²/day) |
| Sample 2 (Uncoated) | 1381 |
| 5 g/m² Topscreen ™ DS54 T + | 494 |
| 2 g/m² Topscreen ™ RP 105 | |
| 5 g/m² Topscreen ™ Bio 4 + | 90 |
| 2 g/m² Topscreen ™ Bio 4 | |
| 5 g/m² Topscreen ™ Bio 4 + | 110 |
| 2 g/m² Topscreen ™ HB50A | |
| 5 g/m² Topscreen ™ Bio 4 + | 193 |
| 2 g/m² Topscreen ™ HB21 | |

TABLE 1b
MOSH/MOAH Test results

| | MOSH MOAH |
|---|---|
| Sample 1 - Testing | (g/m²/day) |
| Sample 1 (Uncoated) | 1554 |
| 5 g/m² Topscreen ™ Bio 4 + | 74 |
| 2 g/m² Topscreen ™ Bio 4 | |

### Example 2—WVTR/OTR Testing

After seeing the heptane test results from Example 1, additional testing on the coatings were accomplished and WVTR and OTR measurements taken. The WVTR testing was conducted according to the ISO 2528 standard or ASTM E-96, the gravimetric cup method, at a temperature of 38° C. and 90% relative humidity (RH). The test was performed manually with deep test dishes, filled with 100 g dry silica gel and a climate chamber to achieve the controlled atmosphere. Every sample is measured in double, and the values given are the averages rounded up. Lower values indicate less water transmission.

Oxygen transmission rate (OTR) measurements are conducted according to the international standard ISO 15105-2 (2003) or ASTM F 1927 (2014) with a test temperature of 23° C. and a relative humidity of both permeant and carrier gas of 50%. Every sample is measured in double, and the values given are the averages rounded up. Lower values indicate less oxygen transmission.

Paper substrates were coated using a multilayer system, i.e., a primer coating layer, an optional middle coating layer, and a topcoat layer. Several TopScreen™ products were tested as a primer coating and as a topcoat. For comparison with the TopScreen™ formulations, TopSol™ 20, a polyvinyl alcohol solution, was used as a middle coating in place of the biodegradable TopScreen™ Bio 4 (a formulation comprising a modified starch polymer, kaolin, and sorbitol). Among the combination of coatings studied, a combination of TopScreen™ DS 3V (a formulation comprising styrene butadiene latex and high aspect ratio talc) and TopScreen™ Bio 4 as the primer or pre-coatings and TopScreen™ DS 20I-F (a formulation comprising styrene butadiene latex and paraffin wax); Additional Topscreen™ products were tested as various coatings layers, i.e., Topscreen™ DS3V, a formulation comprising styrene butadiene latex and high aspect ratio talc; TopScreen DS 54T, a primer coating containing a polyacrylate binder; TopScreen RP 105, a formulation comprising styrene acrylate latexes and biowax; TopScreen HB 50A, a formulation comprising of a polyacrylic binder and low amount of biowax; TopScreen HB 21, a formulation comprising of a polyacrylic binder and high amount of biowax; and TopScreen™ DS 34J, a formulation comprising a styrene acrylate binder and a PEO (polyethylene oxide) wax.

Another objective of the present formulation, is for the coating layer to achieve both excellent oxygen transmission barriers as well as oil and grease resistance. For this the coating needs to be hydrophilic in nature. Although oxygen transmission barriers, and oil and grease share this similarity, it is not self-evident that a good grease resistance results in a good oxygen barrier performance.

Table 2 shows the results when Topscreen™ DS3V was used as the primer coat, a polyvinyl alcohol (Topsol™ 20) was used as a second layer for OTR barrier (Topsol™ 20) with various topcoats.

TABLE 2
Moisture Vapor and Oxygen Transmission Barrier Test Results

| | Coating | | | | | | | | |
|---|---|---|---|---|---|---|---|---|---|
| | 1st | 2nd | | WVTR, | | OTR, | | OGR | |
| | coating | coating | 3rd | 90% RH, 38° C. | | 50% RH, 23° C. | | (KIT | COBB |
| Sample | layer | Layer | layer | n1 | n2 | n1 | n2 | number) | (60 sec) |
| 1 | 5 g/m² | 5 g/m² | 5 g/m² | 82.7 | 83.4 | 7.8 | 5.7 | 12 | 10.6 |
| | TopScreen ™ | Topsol ™ | TopScreen ™ | | | | | | |
| | DS3V | 20 | DS3V | | | | | | |
| 2 | 5 g/m² | 5 g/m² | 5 g/m² | >110 | >110 | 5.9 | 3.7 | 12 | 12.1 |
| | TopScreen ™ | Topsol ™ | TopScreen ™RP | | | | | | |
| | DS3V | 20 | 105 | | | | | | |
| 3 | 5 g/m² | 5 g/m² | 5 g/m² | 44.2 | 47.1 | 8.2 | — | 12 | 7.2 |
| | TopScreen ™ | Topsol ™ | TopScreen ™ | | | | | | |
| | DS3V | 20 | DS201-F | | | | | | |

Results indicated that when the biodegradable coating TopScreen™ Bio 4 is used in a multilayer barrier coating approach instead of TopSol™ 20 not only provided advantages towards runnability, drying capacity, and bio-based content, but also shows better barrier performances and is more economic than fossil-fuel based coatings.

### Example 3

The same procedures as used in Example 2, are used in this Example. This study was accomplished to determine if the order of the coating layers impacted barrier property results. Table 3, shows the results when the polyvinyl alcohol layer is replaced by Topscreen™ Bio 4 and the arrangement of the layers and topcoats is compared. The results show that the polyvinyl alcohol can be replaced, and barrier performance improved by the Topscreen™ Bio 4 layer (using the same dry coat weights for each layer).

TABLE 3
Moisture Vapor and Oxygen Transmission Barrier Test Results

| | | | | WVTR, | | OTR, | | |
|---|---|---|---|---|---|---|---|---|
| | Coating | | | 90% RH, 38° C. | | 50% RH, 25° C. | | |
| Sample | Precoat | Midcoat | Topcoat | n1 | n2 | n1 | n2 | n3 |
| 1 | TopScreen ™ | TopScreen ™ | TopScreen ™ | 56.9 | 55.8 | 99.8 | 10.3 | 8.0 |
| | DS3V | Bio 4 | DS201F | | | | | |
| 2 | TopScreen ™ | TopScreen ™ | TopScreen ™ | 85.1 | 80.2 | 5.6 | 13.0 | — |
| | DS3V | Bio 4 | DS3V | | | | | |
| 3 | TopScreen ™ | TopScreen ™ | — | 104.6 | FAILED | 254.6 | 1.6 | 8.4 |
| | DS3V | Bio 4 | | | | | | |
| 4 | TopScreen ™ | TopScreen ™ | TopScreen ™ | 26.8 | 24.6 | −0.4 | −1.4 | — |
| | Bio 4 | DS3V | DS201F | | | | | |

### Example 4

The same procedures as described in Example 2, were used in this study. The study was conducted on two different paper substrates to determine if the order of the various coating layers, e.g., primer coating, biodegradable coating, or top-coating impacted barrier properties. Therefore, coating order was varied and MVTR and OTR testing accomplished. Results can be found in Table 4.

TABLE 4
MVTR/OTR Testing Results when Changing Coating Order

| | | | | Total | MVTR | | OTR | |
|---|---|---|---|---|---|---|---|---|
| | | | | coat | (g/m² · day) | | (cc/m² · day) | |
| | Primer | Middle | Top | weight | Sample | Sample | Sample | Sample |
| Sample | coating | coating | Coating | (g/m²) | 1 | 2 | 1 | 2 |
| 1 | / | / | 5 g/m² | 5.9 | >1200* | >1200* | 2610 | 88 |
| | | | TopSol ™ 20 | | | | | |
| 2 | / | / | 5 g/m² | 5.3 | >1200* | >1200* | >12500* | >12500* |
| | | | TopScreen ™ | | | | | |
| | | | Bio 4 | | | | | |
| 3 | 5 g/m² | 5 g/m² | 5 g/m² | 15.1 | 178 | 142 | 9.2 | 8.2 |
| | TopScreen ™ | TopSol ™ 20 | TopScreen ™ | | | | | |
| | DS 3V | | DS 20I-F | | | | | |
| 4 | 5 g/m² | 5 g/m² | 5 g/m² | 14.9 | 99 | 84 | 324 | 140 |
| | TopScreen ™ | TopScreen ™ | TopScreen ™ | | | | | |
| | DS 3V | Bio 4 | DS 20I-F | | | | | |
| 5 | 5 g/m² | 5 g/m² | 5 g/m² | 14.8 | 48 | 33 | 66 | 6.1 |
| | TopSol ™ 20 | TopScreen ™ | TopScreen ™ | | | | | |
| | | DS 3V | DS 20I-F | | | | | |
| 6 | 5 g/m² | 5 g/m² | 5 g/m² | 14.2 | 51 | 52 | 207 | 23 |
| | TopScreen ™ | TopScreen ™ | TopScreen ™ | | | | | |
| | Bio 4 | DS 3V | DS 20I-F | | | | | |
| 7 | 5 g/m² | 5 g/m² | 5 g/m² | 15.5 | 49 | 44 | 4.7 | 4.9 |
| | TopScreen ™ | TopSol ™ 20 | TopScreen ™ | | | | | |
| | DS 3V | | DS 34J | | | | | |
| 8 | 5 g/m² | 5 g/m² | 5 g/m² | 16.0 | 80 | 108 | 2350 | 1822 |
| | TopScreen ™ | TopScreen ™ | TopScreen ™ | | | | | |
| | DS 3V | Bio 4 | DS 34J | | | | | |
| 9 | 5 g/m² | 5 g/m² | 5 g/m² | 15.7 | 27 | 29 | 5.1 | 6.1 |
| | TopSol ™ 20 | TopScreen ™ | TopScreen ™ | | | | | |
| | | DS 3V | DS 34J | | | | | |
| 10 | 5 g/m² | 5 g/m² | 5 g/m² | 14.0 | 53 | 40 | 4.1 | 5.0 |
| | TopScreen ™ | TopScreen ™ | TopScreen ™ | | | | | |
| | Bio 4 | DS 3V | DS 34J | | | | | |

*the measured value is above the defined measuring range

Results clearly indicate improved barrier performance when a topcoat layer that includes one or more polymeric emulsions, and one or more wax emulsions, disposed on the surface of the biodegradable coating layer or optional polymeric coating disposed on the surface of the biodegradable coating.

While at least one exemplary embodiment has been presented in the foregoing detailed description of the inventive subject matter. it should be appreciated that a vast number of variations exist. It should also be appreciated that the exemplary embodiment or exemplary embodiments are only examples. and are not intended to limit the scope. applicability. or configuration of the inventive subject matter in any way. Rather, the foregoing detailed description will provide those skilled in the art with a convenient road map for implementing an exemplary embodiment of the inventive subject matter. It being understood that various changes may be made in the function and arrangement of elements described in an exemplary embodiment without departing from the scope of the inventive subject matter as set forth in the appended claims.

What is claimed is:

1. A substrate having improved barrier properties comprising:
a) a substrate having an outermost surface and an innermost surface disposed opposite one another;
b) an optional primer coating layer disposed on and in direct contact with the outermost, innermost, or both surfaces of the substrate;
c) a biodegradable coating layer comprising at least one biodegradable polymeric emulsion, disposed on and in direct contact with the outermost surface, the innermost surface, or both surfaces of the substrate or optional primer coating layer;
d) optionally, one or more polymeric coatings disposed on the surface of the biodegradable coating layer; and
e) a topcoat layer comprising one or more polymeric emulsions, and optionally one or more wax emulsions, disposed on the surface of the biodegradable coating layer or optional polymeric coating disposed on the surface of the biodegradable coating.

2. The substrate according to claim 1, wherein the optional primer coating compromises at least one polymeric emulsion chosen from styrene butadiene, styrene acrylate, polyethylene, polypropylene, polyethylene oxide, polyacrylate, polyvinyl alcohol, polyvinyl acetate, polyvinyl amine, and combinations thereof; and an inorganic pigment slurry chosen from talc, kaolin, calcium carbonate, mica, montmorillonite, and combinations thereof.

3. The substrate according to claim 1, wherein the optional primer coating layer has a polymeric content of from about 30 wt. % to about 70 wt. %, and an inorganic pigment content between 30 wt. % and 70 wt. % based on the total dry weight of the primer coating.

4. The substrate according to claim 1, wherein the optional primer coating is applied at a dry coat weight of from about 1 g/m² to about 50 g/m².

5. The substrate according to claim 1, wherein the at least one biodegradable polymeric emulsion is chosen from polyvinyl alcohol, polyethylene oxide, methylcellulose, cellulose acetate, sodium alginate, polyhydroxyalkanoates, polylactic acid, silk fibroin, soy protein, chitosan, thermoplastic starch, crosslinked starch, and combinations thereof.

6. The biodegradable coating according to claim 1, further comprising a plasticizer chosen from sugar alcohols, glycerol, propylene glycol, glyceryl triacetate, polymeric polyols, urea, ethanol, isopropanol, and combinations thereof.

7. The biodegradable coating according to claim 1, further comprising an inorganic pigment chosen from talc, kaolin, calcium carbonate, mica, montmorillonite, and combinations thereof.

8. The substrate according to claim 1, wherein the biodegradable coating layer has a polymeric content of from about 40 wt. % to about 100 wt. %, a pigment content of from 0 wt. % to about 50 wt. %, and a plasticizer content of from 0 wt. % to about 20 wt. % based on the total dry weight of the biodegradable coating.

9. The substrate according to claim 1, wherein the biodegradable coating is applied at a dry coat weight of from about 1 g/m² to about 50 g/m².

10. The substrate according to claim 1, wherein the one or more polymeric emulsions of the topcoat layer is chosen from styrene butadiene, styrene acrylate, polyethylene, polypropylene, polyethylene oxide, polyacrylate, polyvinyl alcohol, polyvinyl acetate, polyvinyl amine, and combinations thereof.

11. The substrate according to claim 1, wherein the optional one or more wax emulsions of the topcoat layer is chosen from a paraffin, polyethylene, montan, palm, palm kernel, coconut, rapeseed, soybean, sunflower, castor, carnauba, beeswax, shellac, candelilla, sugar cane, rice bran, stearates, laurates, oleates, and combinations thereof.

12. The substrate according to claim 1, wherein the topcoat layer has a polymeric content of from about 50 wt. % to about 100 wt. %, and a wax content of from 0 wt. % to about 50 wt. % based on the total dry weight of the topcoat.

13. The substrate according to claim 1, wherein the topcoat is applied at a dry coat weight of from about 1 g/m² to about 50 g/m².

14. The substrate according to claim 1, wherein the substrate is paper or fiber.

15. A method of providing improved barrier properties of a substrate comprising:
a) providing a substrate having an outermost surface and an innermost surface disposed opposite one another;
b) optionally applying a primer coating layer disposed on and in direct contact with the outermost surface, the innermost surface, or both surfaces of the substrate;
c) applying a biodegradable coating layer comprising at least one biodegradable polymeric emulsion, disposed on and in direct contact with the outermost surface, the innermost surface, or both surfaces of the substrate or optional primer coating layer;
d) optionally applying one or more polymeric coatings disposed on the surface of the biodegradable coating layer; and
e) applying a topcoat layer comprising one or more polymeric emulsions, and optionally, one or more wax emulsions, disposed on the surface of the biodegradable coating layer or optional polymeric coating disposed on the surface of the biodegradable coating.

16. The method according to claim 15, wherein the optional primer coating is applied to the substrate at a dry coat weight of from about 1 g/m² to about 50 g/m².

17. The method according to claim 15, wherein the biodegradable coating further comprises a plasticizer and/or an inorganic pigment.

18. The method according to claim 15, wherein the biodegradable coating is applied at a dry coat weight of from about 1 g/m² to about 50 g/m².

19. The method according to claim 15, wherein the topcoat is applied at a dry coat weight of from about 1 g/m² to about 50 g/m².

20. The method according to claim 15, wherein the substrate is paper or fiber.
